(19) United States
(12) Patent Application Publication
(10) Pub. No.: US 2014/0320462 A1
(43) Pub. Date: Oct. 30, 2014

(54) STYLUS, SYSTEM AND METHOD FOR PROVIDING HAPTIC FEEDBACK

(71) Applicant: Acer Incorporated, New Taipei City (TW)

(72) Inventors: Hsu-Hsiang Tseng, New Taipei City (TW); Tzung-Heng Tsao, New Taipei City (TW); Tse-Chia Huang, New Taipei City (TW); Kuang-Rong Lu, New Taipei City (TW)

(73) Assignee: Acer Incorporated, New Taipei City (TW)

(21) Appl. No.: 14/028,548

(22) Filed: Sep. 17, 2013

(30) Foreign Application Priority Data
Apr. 30, 2013 (TW) 102115473

(51) Int. Cl. G06F 3/0354

(52) U.S. Cl. CPC G06F 3/03545
USPC 345/179

(57) ABSTRACT

A method for providing a haptic feedback is provided. The method includes sending out a stylus activation signal by a stylus when the stylus enters an active state. The method also includes receiving the stylus activation signal by an electronic device, and transmitting a corresponding feedback effect signal to the stylus by the electronic device while an event to be notified occurs. The method further includes providing the haptic feedback in accordance with the feedback effect signal by the stylus.

### CROSS-REFERENCE TO RELATED APPLICATION

This application claims the priority benefit of Taiwan application serial no. 102115473, filed on Apr. 30, 2013. The entirety of the above-mentioned patent application is hereby incorporated by reference herein and made a part of this specification.

### BACKGROUND

1. Technical Field

The invention relates to an application of operation feedback. Particularly, the invention relates to a stylus, a system and a method for providing haptic feedback.

2. Related Art

Along with booming development of mobile electronic devices, in order to control a device volume and increase a size of displayed images, it has becomes a main stream in design of electronic devices to use a touch screen as both of an input interface and an output interface. Along with increasing growth of related applications of the touch screen, besides devices emphasizing the characteristic of portability such as smart phones, tablet PCs or notebook computers, etc., even desktop computers successively introduce the touch technology to facilitate user's operation.

When a user operates a device supporting a touch input, the user's finger and a stylus are commonly used input tools, and since the stylus may produce fine drawings and text, in recent years, more and more users start to use the stylus in collaboration with the electronic device to replace the function of handwriting input. However, when the user uses the existing stylus to write on a glass substrate of the touch screen, the user can only get a cold and monotonous writing experience, which is completely unable to match effects of writing on different materials by using different writing tools in real life, and cannot provide the user a better usage experience.

### SUMMARY

The invention is directed to a stylus, a system and a method for providing haptic feedback, by which when a user uses a stylus to operate an electronic device, the stylus provides a suitable haptic feedback.

The invention provides a method for providing a haptic feedback, which includes following steps. A stylus activation signal is sent by a stylus when the stylus enters an active state. After the stylus activation signal is received by an electronic device, when an event to be notified occurs, the electronic device transmits a feedback effect signal corresponding to the event to be notified to the stylus. Then, a haptic feedback is provided by the stylus according to the feedback effect signal.

The invention provides a haptic feedback providing system including a stylus and an electronic device. The stylus includes a stylus transmission interface, a control unit and a haptic feedback unit. The stylus transmission interface sends a stylus activation signal when the stylus enters an active state. The control unit is coupled to the stylus transmission interface, and the haptic feedback unit is coupled to the control unit. The electronic device includes a device transmission interface and a processing unit. After the device transmission interface receives the stylus activation signal, the processing unit transmits a feedback effect signal corresponding to an event to be notified to the stylus when the event to be notified occurs. The control unit of the stylus controls the haptic feedback unit to provide a corresponding haptic feedback according to the feedback effect signal received by the stylus transmission interface.

The invention provides a stylus including a stylus transmission interface, a control unit and a haptic feedback unit. The stylus transmission interface sends a stylus activation signal when the stylus enters an active state. The control unit is coupled to the stylus transmission interface, and the haptic feedback unit is coupled to the control unit. The control unit determines whether a feedback effect signal is received from an electronic device through the stylus transmission interface after the stylus activation signal is sent, where the feedback effect signal is sent by the electronic device when an event to be notified occurs after the electronic device receives the stylus activation signal. After the feedback effect signal is received from the electronic device, the control unit controls the haptic feedback unit to provide a corresponding haptic feedback according to the feedback effect signal.

According to the above descriptions, when the user uses the stylus to operate on the electronic device, the stylus provides corresponding haptic feedbacks according various events to be notified that are occurred on the electronic device. By providing the haptic feedback by the stylus, the feedback effect can be directly transmitted to the user, which facilitates the user identifying different events to improve usage convenience of the electronic device.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a haptic feedback providing system according to an embodiment of the invention.

FIG. 2 is a schematic diagram of an appearance of a stylus according to an embodiment of the invention.

FIG. 3 is a flowchart illustrating a method for providing haptic feedback according to an embodiment of the invention.

FIG. 4 is a flowchart illustrating a method for transmitting a feedback effect signal according to an embodiment of the invention.

FIG. 5 is a schematic diagram of a touch panel according to an embodiment of the invention.

FIG. 6 is a schematic diagram of a touch panel according to another embodiment of the invention.

FIG. 7 is a flowchart illustrating a method for transmitting a feedback effect signal according to another embodiment of the invention.

### DETAILED DESCRIPTION OF DISCLOSED EMBODIMENTS

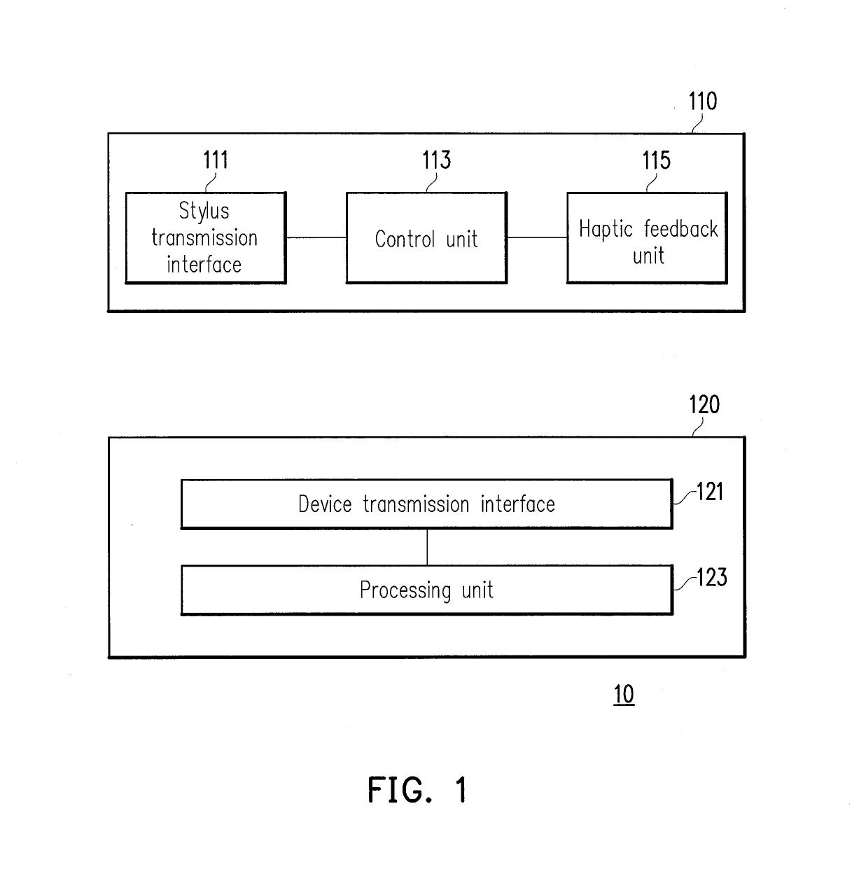

FIG. 1 is a schematic diagram of a haptic feedback providing system according to an embodiment of the invention. Referring to FIG. 1, the haptic feedback providing system 10 includes a stylus 110 and an electronic device 120. The electronic device 120 is, for example, a smart phone, a personal digital assistant, a tablet PC, a game machine or an E-book, etc., and the stylus 110 is, for example, an active stylus or other tools used by a user to implement input of the electronic device 120, which is not limited by the invention.

Referring to FIG. 1, the stylus 110 includes a stylus transmission interface 111, a control unit 113 and a haptic feedback unit 115. The stylus transmission interface 111 and the haptic feedback unit 115 are respectively coupled to the control unit 113. It should be noticed that the stylus 110 may further include other devices, for example, a main control unit, a power module and a memory unit, etc.

In the present embodiment, the stylus transmission interface 111 is, for example, a bluetooth interface. In other embodiments, the stylus transmission interface 111 can be a wireless fidelity (WiFi) interface, a near field communication (NFC) interface, an infrared transmission interface, or any interface supporting wireless communication, which is not limited by the invention. The stylus transmission interface 111 is used for sending signals generated by the stylus 110 and receiving signals come from other devices.

The control unit 113 is mainly in charge of controlling a haptic feedback mechanism of the stylus 110, for example, controlling the haptic feedback unit 115 to provide a corresponding haptic feedback according to a special signal received by the stylus transmission interface 111. In an embodiment, the haptic feedback unit 115 is a vibration motor, and the control unit 113 dominates the haptic feedback unit 115 to provide various haptic feedbacks by controlling a time of supplying power to the haptic feedback unit 115 and a magnitude of voltage provided thereto. In another embodiment, the haptic feedback unit 115 is composed of a piezoelectric material, and the control unit 113 supplies electricity to two ends of the piezoelectric material to control the piezoelectric material to present a vibration effect. It should be noticed that the haptic feedback unit 115 can be any device capable of providing a vibration effect, which is not limited by the invention.

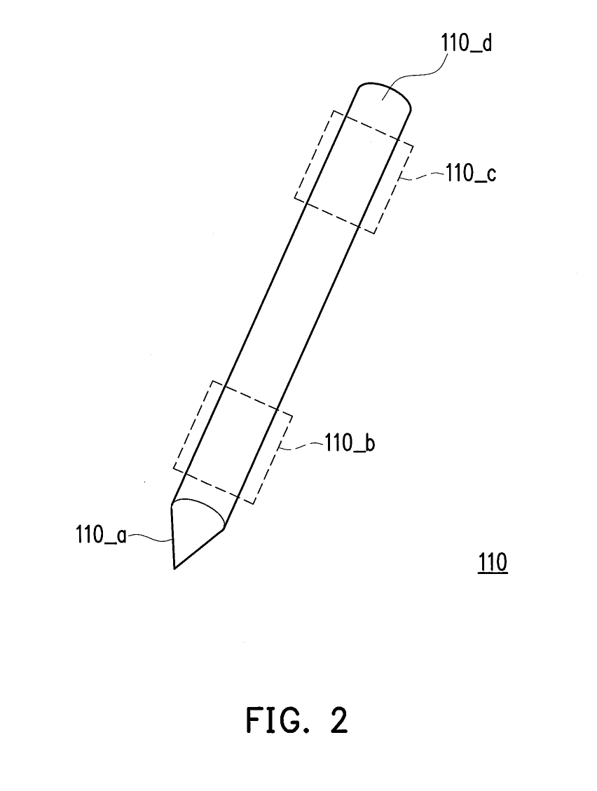

In the haptic feedback providing system 10, the stylus 110 provides the haptic feedback through the vibration effect provided by the haptic feedback unit 115, and a configuration position of the haptic feedback unit 115 in the stylus 110 is determined based on a pen holding habit of most people. According to statistics, when most of the users use an input tool like the stylus, the fingertip of the user contacts the stylus at a position near a penpoint of the stylus, and a tail of the stylus leans against the part of the hand between the thumb and the index finger. As shown in FIG. 2, the haptic feedback unit 115 can be disposed in a first region 110_{—}b near a penpoint 110_{—}a. Alternatively, the haptic feedback unit 115 can be disposed in a second region 110_{—}c near a tail 110_{—}d of the stylus. In order to strengthen the effect of the haptic feedback, the haptic feedback unit 115 can be simultaneously disposed in the first region 110_{—}b and the second region 110_{—}c. By configuring the haptic feedback unit 115 in the first region 110_{—}b and/or the second region 110_{—}c, the user can clearly feel the haptic feedback when holding the stylus 110. However, the aforementioned configurations are only examples, and the invention is not limited thereto.

Referring to FIG. 1, the electronic device 120 of the present embodiment includes a device transmission interface 121 and a processing unit 123 mutually coupled to each other. Besides, the electronic device 120 may further includes other modules such as a touch panel, a power module, a memory unit, etc.

In the present embodiment, the device transmission interface 121 can be a bluetooth interface corresponding to the stylus transmission interface 111. In other embodiments, the device transmission interface 121 can also be a WiFi interface, a NFC interface, an infrared transmission interface, or any interface supporting wireless communication. The device transmission interface 121 is in charge of sending out signals generated by the electronic device 120 and receiving signals come from other devices.

The processing unit 123 is in charge of controlling operations of the electronic device 120, and can be a central processing unit (CPU) or a programmable general-purpose or special-purpose microprocessor, a digital signal processor (DSP), a programmable controller, an application specific integrated circuit (ASIC) or other similar device or a combination of the aforementioned devices.

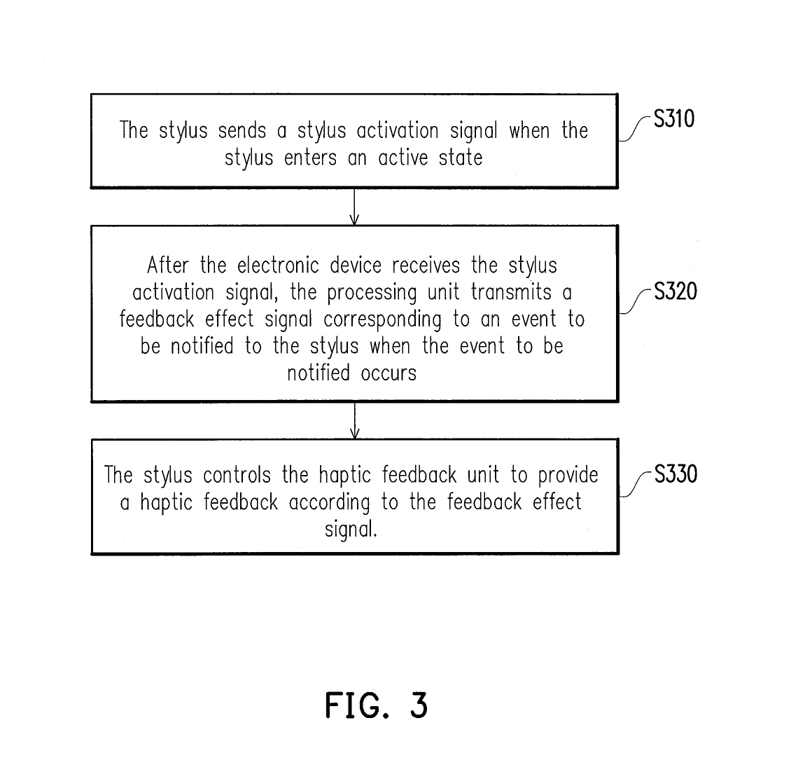

In the present embodiment, once the user starts to use the stylus 110 to operate the electronic device 120, the stylus 110 suitably generates a haptic feedback. It should be noticed that the stylus 110 provides a corresponding haptic feedback according to a position of a touch point, information provided by a program executed on the electronic device 120, or a setting of the user. In order to further describe a detailed operation method of the haptic feedback providing system 10, detailed steps of the method for providing haptic feedback of the invention are described below with reference of FIG. 3.

Referring to FIG. 1 and FIG. 3, in step S310, when the stylus 110 enters an active state, the stylus 110 sends a stylus activation signal through the stylus transmission interface 111. The active state refers to that the stylus 110 can be used to operate the electronic device 120. In an embodiment, the active state is that the power of the stylus 110 is turned on. In another embodiment, the penpoint of the stylus 110 is stretchable, and once the penpoint contacts a plane to retract, the stylus 110 enters the active state.

Since the stylus transmission interface 111 of the stylus 110 and the device transmission interface 121 of the electronic device 120 have a same interface type and can transmit data to each other, the device transmission interface 121 can receive the stylus activation signal sent by the stylus 110, and the electronic device 120 accordingly learns existence of the stylus 110. Then, in step S320, after the device transmission interface 121 receives the stylus activation signal, when the processing unit 123 perceives occurrence of an event to be notified, the processing unit 123 transmits a feedback effect signal corresponding to the event to be notified to the stylus 110 through the device transmission interface 121. For example, the event to be notified is a touch event detected by the touch panel of the electronic device and/or a notification event generated by a program installed in the electronic device 120. How the processing unit 123 determines the feedback effect signal to be transmitted according to the event to be notified is described below with reference of figures.

After the stylus transmission interface 111 of the stylus 110 receives the feedback effect signal from the electronic device 120, in step S330, the control unit 113 of the stylus 110 controls the haptic feedback unit 115 to provide a haptic feedback according to the feedback effect signal. For example, the control unit 113 can obtain a vibration period, a vibration frequency and an amplitude corresponding to the feedback effect signal according to a lookup table, and determines a voltage variation manner (for example, a strength and power supplying time) required for making the haptic feedback unit 115 to generate the haptic feedback complied with the vibration period, the vibration frequency and the amplitude. After the control unit 113 supplies power to the haptic feedback unit 115 according to the determined voltage variation manner and power supplying time, the haptic feedback unit 115 provides the corresponding haptic feedback, for example, the longer the power supplying time is, the longer the effect of the haptic feedback is, and the higher the supplied power is, the higher the vibration frequency or the amplitude is.

A plurality of embodiments are provided below to describe how the processing unit 123 of the electronic device 120 determines the feedback effect signal to be transmitted to the stylus 110 according to the event to be notified.

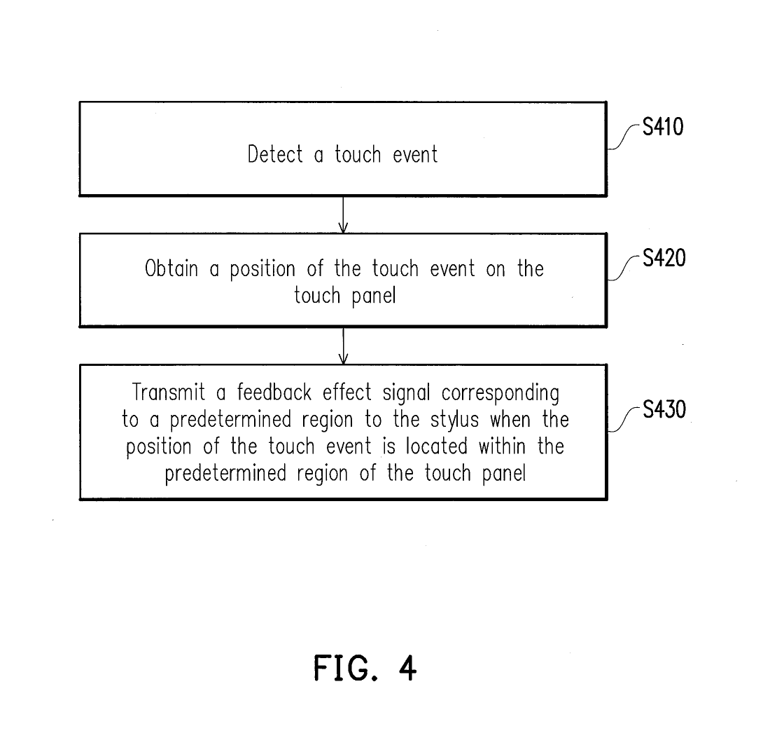

In an embodiment, the electronic device 120 includes a touch panel coupled to the processing unit 123, and the touch panel is an input and output interface of the electronic device 120. In other words, the touch panel may receive a touch operation from user's finger or the stylus 110, and can display various images generated during the operation of the electronic device 120. In the present embodiment, the event to be notified is the touch event detected by the touch panel. As shown in FIG. 4, when the touch panel detects the touch event (step S410), the processing unit 123 obtains a position of the touch event on the touch panel (step S420), and when the position of the touch event is located within a predetermined region of the touch panel, the processing unit 123 transmits a feedback effect signal corresponding to the predetermined region to the stylus 110 (step S430).

For example, when the user uses different types of writing tools to write on different writing surfaces in real life, the user may have different writing experiences. For example, different thickness and hardness of the penpoint of the writing tool and different evenness of the writing surface may cause different degrees of smooth feeling and frictional feeling. In order to use different vibration effects to simulate different writing experiences caused when different writing tools are used to write on different types of the writing surfaces in real life, the electronic device 120 displays one or a plurality of feedback effect setting options on the touch panel to facilitate the user to select the writing tool and the writing surface to be used. The writing tool includes a pencil, a ball pen, a fountain pen, a brush pen, a spray gun, an engraving pen, etc., and the writing surface includes paper, wooden board and leather, etc. The predetermined region mentioned in the step S430 of FIG. 4 is a display region of each feedback effect setting option.

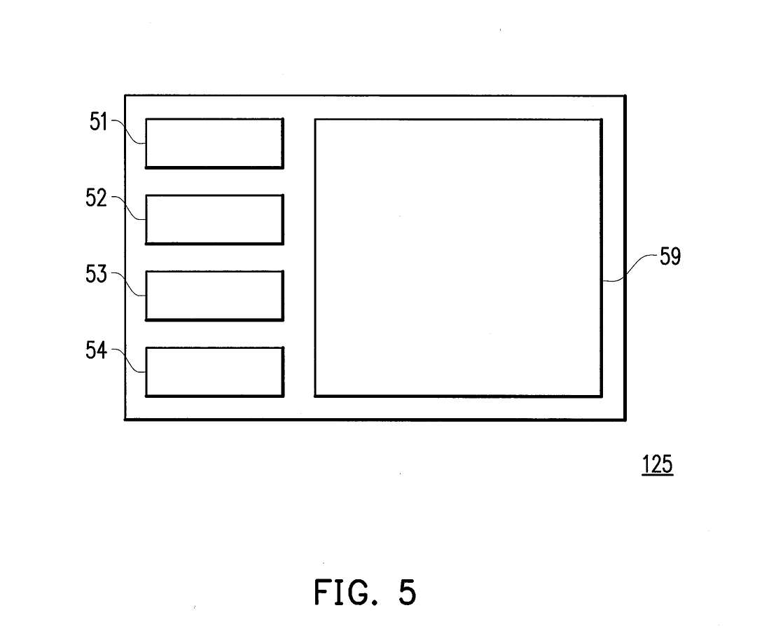

Taking the embodiment of FIG. 5 as an example, the touch panel 125 of the electronic device 120 displays four feedback effect setting options 51, 52, 53 and 54 for the user to select. The feedback effect setting options 51, 52, 53 and 54 respectively correspond to a combination of a writing tool and a writing surface. If the user selects one of the feedback effect setting options (for example, the feedback effect setting option 51), the touch event detected by the touch panel 125 is located in the display region of the feedback effect setting option 51, and the processing unit 123 determines the feedback effect signal corresponding to the display region of the feedback effect setting option 51 through a table lookup method, and transmits the feedback effect signal to the stylus 110 through the device transmission interface 121. It is assumed that the combination of the writing tool and the writing surface corresponding to the feedback effect setting option 51 is pencil and paper, the control unit 113 of the stylus 110 can obtain the corresponding vibration period, the vibration frequency and the amplitude according to the feedback effect signal come from the electronic device 120, so as to control the haptic feedback unit 115 to provide the haptic feedback corresponding to the combination of pencil and paper. In other words, when the user uses the stylus 110 to write on an editing region 59 on the touch panel 125 of the stylus 110 thereafter, the user may have a writing experience similar as that of actually using a pencil to write on paper through the haptic feedback sent by the stylus 110.

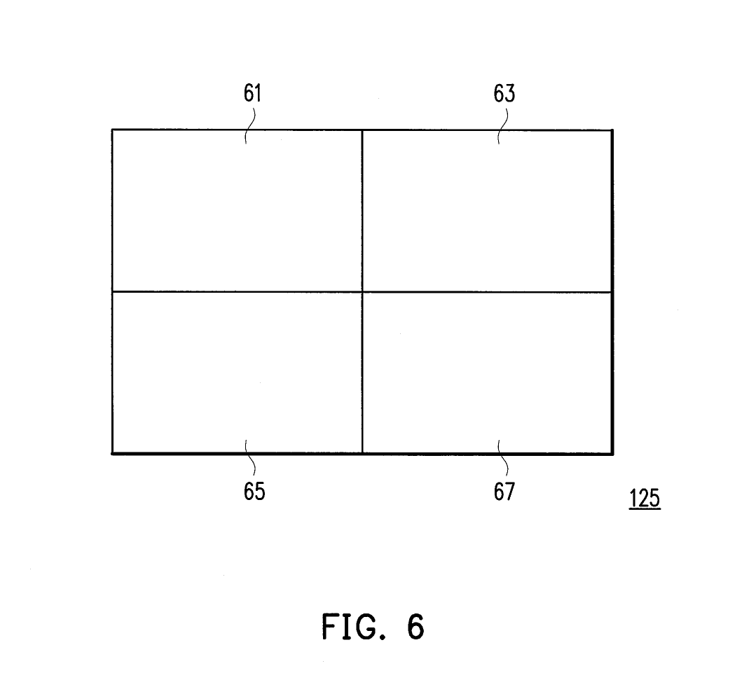

In an example of FIG. 6, the touch panel 125 of the electronic device 120 is divided into four predetermined divided regions 61, 63, 65 and 67 in advance, and each of the predetermined divided regions corresponds to a combination of the writing tool and the writing surface. The predetermined region mentioned in the step S430 of FIG. 4 is one of the predetermined divided regions of the touch panel. In the present exemplary embodiment, when the user uses the stylus 110 to write in one of the predetermined divided regions (for example, the predetermined divided region 61), the processing unit 123 obtains the feedback effect signal corresponding to the predetermined divided region 61 through a table lookup method, and transmits the feedback effect signal to the stylus 110 through the device transmission interface 121. Since the control unit 113 of the stylus 110 can obtain the corresponding vibration period, the vibration frequency and the amplitude according to the received feedback effect signal, and provides the corresponding touch feedback through the haptic feedback unit 115. It is assumed that the combination of the writing tool and the writing surface corresponding to the predetermined divided region 61 is an engraving pen and a wooden board, each time when the user writes in the predetermined divided region 61, the stylus 110 can provide a haptic feedback equivalent to an experience of using the engraving pen to engrave the wooden plate to the user.

Besides, the predetermined region mentioned in the step S430 of FIG. 4 can also be a display region of software keys, where the software keys can be any key on a software input panel (SIP), options in a user interface, or shortcuts of application programs, etc. When the user uses the stylus 110 to select a certain software key, the processing unit 123 transmits the feedback effect signal corresponding to the software key to the stylus 110. In this way, the user can confirm that the software key has been selected through the haptic feedback output by the haptic feedback unit 115

In the following embodiment, the event to be notified is related to the program installed in the electronic device 120. For example, one or a plurality of programs are installed in the electronic device 120, and the programs can be built-in programs installed in the electronic device 120 by the manufacturer before delivery, or can be application programs downloaded by the user. The event to be notified is a notification event generated by a program installed in the electronic device 120.

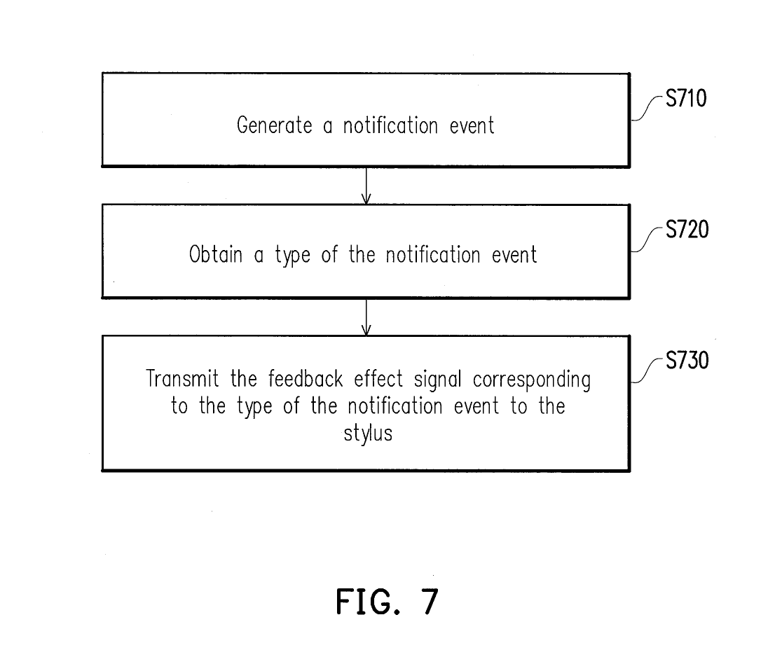

Referring to FIG. 7, in step S710, the program generates the notification event. Then, in step S720, the processing unit 123 obtains a type of the notification event, where the type includes incoming call notification, text message notification, multimedia message notification, social network service notification, mail notification, alarm notification, calendar reminder notification or text input error notification, etc., though the invention is not limited thereto. In step S730, the processing unit 123 transmits the feedback effect signal corresponding to the type of the notification event to the stylus 110.

For example, it is assumed that the user activates a text editing application and uses the stylus 110 to perform text input, if the text editing application has a word debug capability, when the text input by the user has an error, the text editing application can generate a notification event with a type of text input error notification, and the processing unit 123 determines the feedback effect signal to be transmitted to the stylus 110 according to the type of the notification event. In this way, after the stylus 110 receives the feedback effect signal, the control unit 113 controls the haptic feedback unit 115 to generate the corresponding haptic feedback. The user can perceive that the text input has an error according to the haptic feedback.

In another example, when an E-mail application installed in the electronic device 120 receives a new E-mail from a mail server, the E-mail application generates a notification event with a type of mail notification, and the processing unit 123 determines the corresponding feedback effect signal according to the notification event, and transmits the feedback effect signal to the stylus 110. The control unit 113 of the stylus 110 controls the haptic feedback unit 115 to generate the corresponding haptic feedback according to the received feedback effect signal, and the user can learn that there is a new mail according to the haptic feedback sent by the stylus 110.

In the aforementioned embodiment, during the period that the stylus 110 is used to operate the electronic device 120, the stylus 110 replaces the electronic device 120 to provide a suitable haptic feedback. In other words, when any event to be notified and required to notify the user occurs, the stylus 110 provides the haptic feedback, and the electronic device 120 does not provide a haptic alert effect (for example, does not send a vibration alert).

In order to achieve the aforementioned effect, the processing unit 123 of the electronic device 120 has to effectively determine whether the stylus 110 is still used to operate the electronic device 120. In an embodiment, the stylus 110 can continually sends the stylus activation signal through the stylus transmission interface 111 as long as the stylus 110 is in the active state, so that the processing unit 123 of the electronic device 120 can determine whether the stylus 110 has left the active state according to whether the stylus activation signal is not received for a long time. For example, the processing unit 123 determines whether a time interval since last reception of the stylus activation signal does not exceed a predetermined value (for example, 3 seconds, though the invention is not limited thereto). If the time interval does not exceed the predetermined value, it represents that the stylus 110 is still in the active state, and can still be used to operate the electronic device 120, so that even if the event to be notified occurs, the processing unit 123 still controls the electronic device 120 not to provide a haptic feedback related to the event to be notified.

For example, the user sets the electronic device 120 to send a vibration alert when receiving a phone call, though in the present embodiment, when the user uses the stylus 110 to perform input to the electronic device 120, when the electronic device 120 receives a phone call, the electronic device 120 itself does not send the vibration alert, instead, the stylus 110 provides a corresponding haptic feedback to notify the user that a phone call is received.

In summary, according to the method, system and stylus for providing haptic feedback, when the user uses the stylus to operate the electronic device, the stylus suitably provides a corresponding haptic feedback. Since most of the users hold the stylus in a similar way, if the stylus is used to provide the haptic feedback, it is more easy to define an effective vibration region, so that the vibration effect can be directly transferred to the user, and the user can obtain better operation experience though the haptic feedback.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for providing haptic feedback, comprising:
sending a stylus activation signal by a stylus when the stylus enters an active state;
receiving the stylus activation signal by an electronic device, and transmitting a feedback effect signal corresponding to an event to be notified to the stylus by the electronic device when the event to be notified occurs; and
providing a haptic feedback by the stylus according to the feedback effect signal.

2. The method for providing haptic feedback as claimed in claim 1, wherein the event to be notified is a touch event detected by a touch panel of the electronic device, and the step of receiving the stylus activation signal by the electronic device, and transmitting the feedback effect signal corresponding to the event to be notified to the stylus by the electronic device when the event to be notified occurs comprises:
obtaining a position of the touch event on the touch panel; and
transmitting the feedback effect signal corresponding to a predetermined region to the stylus when the position is located within the predetermined region of the touch panel.

3. The method for providing haptic feedback as claimed in claim 2, wherein the predetermined region is a display region of a feedback effect setting option, a display region of a software key, or one of a plurality of predetermined divided regions of the touch panel.

4. The method for providing haptic feedback as claimed in claim 1, wherein the event to be notified is a notification event generated by a program installed in the electronic device, and the step of receiving the stylus activation signal by the electronic device, and transmitting the feedback effect signal corresponding to the event to be notified to the stylus by the electronic device when the event to be notified occurs comprises:
obtaining a type of the notification event; and
transmitting the feedback effect signal corresponding to the type of the notification event to the stylus.

5. The method for providing haptic feedback as claimed in claim 1, wherein the stylus continually sends the stylus activation signal under the active state, and the method further comprises:
determining whether a time interval since last reception of the stylus activation signal does not exceed a predetermined value by the electronic device; and
not to provide the haptic feedback related to the event to be notified by the electronic device when the event to be notified occurs if the time interval does not exceed the predetermined value.

6. The method for providing haptic feedback as claimed in claim 1, wherein the step of providing the haptic feedback by the stylus according to the feedback effect signal comprises:
obtaining a vibration period, a vibration frequency and an amplitude corresponding to the feedback effect signal; and
providing the haptic feedback according to the vibration period, the vibration frequency and the amplitude.

7. A haptic feedback providing system, comprising:
a stylus, comprising:
a stylus transmission interface, sending a stylus activation signal when the stylus enters an active state;
a control unit, coupled to the stylus transmission interface; and
a haptic feedback unit, coupled to the control unit; and
an electronic device, comprising:
a device transmission interface; and
a processing unit, coupled to the device transmission interface, wherein after device transmission interface receives the stylus activation signal, the processing unit transmits a feedback effect signal corresponding to an event to be notified to the stylus when the event to be notified occurs,
wherein the control unit of the stylus controls the haptic feedback unit to provide a corresponding haptic feedback according to the feedback effect signal received by the stylus transmission interface.

8. The haptic feedback providing system as claimed in claim 7, wherein the electronic device further comprises:
a touch panel, coupled to the processing unit, wherein the event to be notified is a touch event detected by the touch panel,
wherein the processor obtains a position of the touch event on the touch panel, and transmits the feedback effect signal corresponding to a predetermined region to the stylus through the device transmission interface when the position is located within the predetermined region of the touch panel.

9. The haptic feedback providing system as claimed in claim 8, wherein the predetermined region is a display region of a feedback effect setting option, a display region of a software key, or one of a plurality of predetermined divided regions of the touch panel.

10. The haptic feedback providing system as claimed in claim 7, wherein the event to be notified is a notification event generated by a program installed in the electronic device, and the processing unit obtains a type of the notification event, and transmits the feedback effect signal corresponding to the type to the stylus through the device transmission interface.

11. The haptic feedback providing system as claimed in claim 7, wherein the stylus continually sends the stylus activation signal through the stylus transmission interface under the active state,
the processing unit determines whether a time interval since last reception of the stylus activation signal does not exceed a predetermined value,
if the time interval does not exceed the predetermined value, the processing unit controls the electronic device not to provide the haptic feedback related to the event to be notified when the event to be notified occurs.

12. The haptic feedback providing system as claimed in claim 7, wherein the control unit obtains a vibration period, a vibration frequency and an amplitude corresponding to the feedback effect signal, and controls the haptic feedback unit to provide the haptic feedback according to the vibration period, the vibration frequency and the amplitude.

13. A stylus, comprising:
a stylus transmission interface, sending a stylus activation signal when the stylus enters an active state;
a control unit, coupled to the stylus transmission interface; and
a haptic feedback unit, coupled to the control unit,
wherein the control unit determines whether a feedback effect signal is received from an electronic device through the stylus transmission interface after the stylus activation signal is sent, wherein the feedback effect signal is sent by the electronic device when an event to be notified occurs after the electronic device receives the stylus activation signal,
after the feedback effect signal is received from the electronic device, the control unit controls the haptic feedback unit to provide a corresponding haptic feedback according to the feedback effect signal.

14. The stylus as claimed in claim 13, wherein the event to be notified is a touch event detected by a touch panel of the electronic device, and the feedback effect signal corresponds to a position of the touch event on the touch panel.

15. The stylus as claimed in claim 13, wherein the event to be notified is a notification event generated by a program installed in the electronic device, and the feedback effect signal corresponds to a type of the notification event.

16. The stylus as claimed in claim 13, wherein the control unit obtains a vibration period, a vibration frequency and an amplitude corresponding to the feedback effect signal, and controls the haptic feedback unit to provide the haptic feedback according to the vibration period, the vibration frequency and the amplitude.
